(19) United States
(12) Patent Application Publication
(10) Pub. No.: US 2020/0408542 A1
(43) Pub. Date: Dec. 31, 2020

(54) SERVER DEVICE AND METHOD OF PROVIDING IMAGE

(71) Applicant: TOYOTA JIDOSHA KABUSHIKI KAISHA, Toyota-shi (JP)

(72) Inventors: Yoshihiro Oe, Kawasaki-shi (JP); Kazuya Nishimura, Okazaki-shi (JP); Jun Goto, Toyota-shi (JP); Hirofumi Kamimaru, Fukuoka-shi (JP)

(73) Assignee: TOYOTA JIDOSHA KABUSHIKI KAISHA, Toyota-shi (JP)

(21) Appl. No.: 16/859,089

(22) Filed: Apr. 27, 2020

(30) Foreign Application Priority Data
Jun. 27, 2019 (JP) 2019-120288

(51) Int. Cl. G01C 21/34; G06K 9/00; G01C 21/36; G01S 19/42

(52) U.S. Cl. CPC G01C 21/3407; G06K 9/00791; G01C 21/3623; G01S 19/421; G01S 2205/01; G01C 21/3691; G01C 21/3667; G01S 2201/01; G01C 21/3626

(57) ABSTRACT

A server device includes an acquisition unit configured to acquire, from an in-vehicle device, a captured image obtained by capturing an image in front of a vehicle and imaging position information indicating a position where the captured image is captured, a holding unit configured to hold a model image, which is generated from a series of captured images including a vehicle turning at an intersection and includes a vehicle turning at the intersection as a model vehicle, in association with the imaging position information, and a providing unit configured to provide the model image to a vehicle scheduled to turn at the intersection corresponding to the model image.

### INCORPORATION BY REFERENCE

The disclosure of Japanese Patent Application No. 2019-120288 filed on Jun. 27, 2019 including the specification, drawings and abstract is incorporated herein by reference in its entirety.

### BACKGROUND

### 1. Technical Field

The present disclosure relates to a technique for providing an image for use in a route guide to an in-vehicle device.

### 2. Description of Related Art

Japanese Unexamined Patent Application Publication No. 2017-129406 (JP 2017-129406 A) discloses an information processing device including a display unit that displays a pace car leading to a destination using an AR technique. The pace car is a virtually generated display image, and a display position and a shape of the pace car are decided based on an inter-vehicle distance and a vehicle speed which are determined in advance.

### SUMMARY

In the technique disclosed in JP 2017-129406 A, the display unit displays the pace car to guide a driver to the destination; however, since the pace car is the virtually generated display image, there is a possibility that the pace car greatly deviates from an image being actually viewed.

The disclosure provides a technique for allowing a driver to easily ascertain a guide route.

A first aspect of the disclosure relates to a server device. The server device includes an acquisition unit, a holding unit, and a providing unit. The acquisition unit is configured to acquire, from an in-vehicle device, a captured image obtained by capturing an image in front of a vehicle and imaging position information indicating a position where the captured image is captured. The holding unit is configured to hold a model image, which is generated from a series of captured images including a vehicle turning at an intersection and includes a vehicle turning at the intersection as a model vehicle, in association with the imaging position information. The providing unit is configured to provide the model image to a vehicle scheduled to turn at the intersection corresponding to the model image.

A second aspect of the disclosure relates to a method of providing an image. The method includes a step of acquiring, from an in-vehicle device, a captured image obtained by capturing an image in front of a vehicle and imaging position information indicating a position where the captured image is captured, a step of holding a model image, which is generated from a series of captured images including a vehicle turning at an intersection and includes a vehicle turning at the intersection as a model vehicle, in association with the imaging position information, and a step of providing the model image to a vehicle scheduled to turn at the intersection corresponding to the model image.

According to the aspects of the disclosure, it is possible to provide a technique for allowing a driver to easily ascertain a guide route.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a route guide image that is displayed on a display device of an example;

FIG. 2 is a diagram showing the outline of an image providing system;

FIG. 3 is a diagram showing functional blocks of the image providing system of the example;

FIG. 4 is a flowchart of processing for generating a model image; and

FIG. 5 is a flowchart of processing for providing a model image.

### DETAILED DESCRIPTION OF EMBODIMENTS

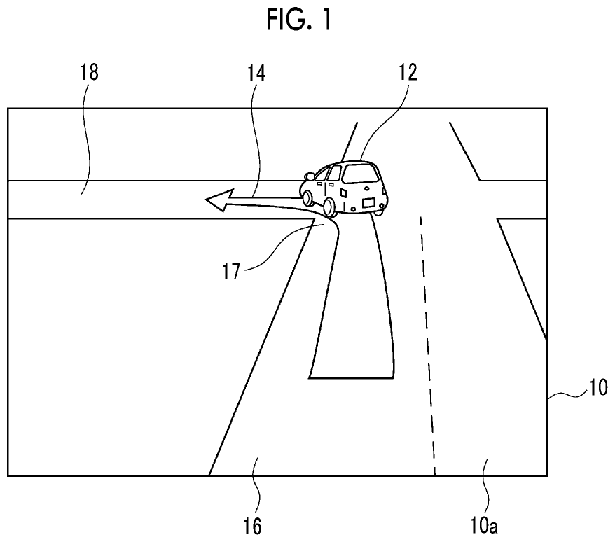

FIG. 1 is a diagram showing a route guide image 10a that is displayed on a display device 10 of an example. The display device 10 is a display that is mounted in a vehicle and outputs a navigation function of guiding a driver a route in a form of an image. In FIG. 1, when the vehicle is traveling on a traveling road 16, the navigation function makes the route guide image 10a be displayed to guide the vehicle from the traveling road 16 to a guide road 18. The route guide image 10a is generated by superimposing a model image 12 and a guidance image 14 on a captured image obtained by capturing an image in front of the vehicle.

The model image 12 is one frame of video indicating a series of processes of turning left at an intersection 17 as a leading vehicle, and is an image of a vehicle that has actually turned left at the intersection 17 in the past. The guidance image 14 is an arrow indicating a guidance direction, and indicates left turn at the intersection 17.

When the driver is guided to turn left at the intersection 17, in a case where there is no mark, such as a point of interest (POI), at the intersection 17, the driver may hardly ascertain a position of the intersection 17. Accordingly, in the route guide image 10a of the display device 10, the model image 12 is displayed to allow the driver to easily recognize the intersection 17 to be turned.

Since the model image 12 for a route guide is video of the vehicle that has actually turned left at the intersection 17, the driver can view the movement of the vehicle that has been actually driven, and easily ascertain how to turn at the intersection 17. For example, a position where the vehicle starts to turn is not clear solely with the guide of the arrow; however, since video of the vehicle that has actually traveled is displayed on an actual road image in a superimposed manner, the driver can drive to follow the model image 12.

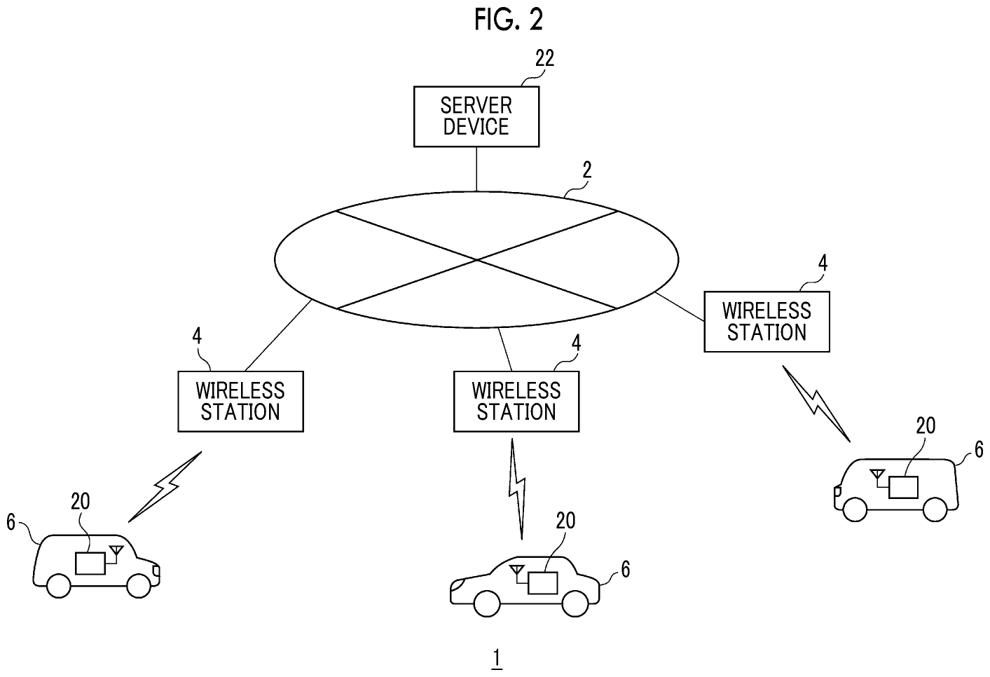

FIG. 2 is a diagram showing the outline of an image providing system 1. The image providing system 1 includes a server device 22, a plurality of wireless stations 4, and a plurality of vehicles 6. The server device 22 and the wireless stations 4 may be connected through a network 2, such as the Internet.

An in-vehicle device 20 is mounted in the vehicle 6. The in-vehicle device 20 has a wireless communication function and is connected to the server device 22 by way of the wireless station 4 as a base station. The number of vehicles 6 is not limited to three. In the image providing system 1, a situation in which many vehicles 6 generate vehicle information and transmit the vehicle information to the server device 22 cyclically is assumed. The server device 22 is provided in a data center, and receives the vehicle information transmitted from the in-vehicle device 20 of the vehicle 6.

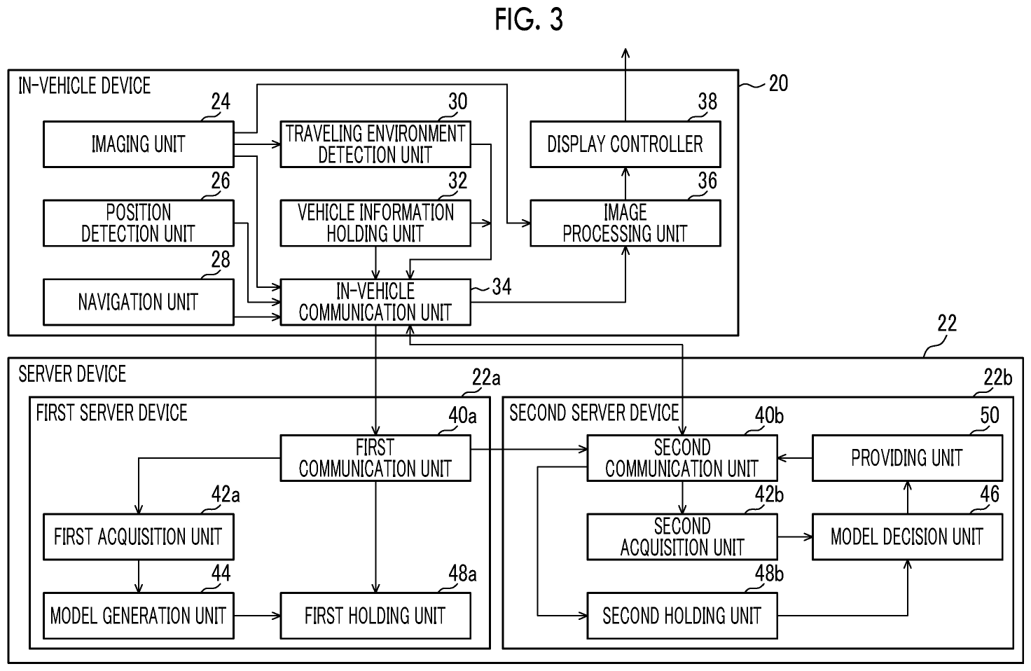

FIG. 3 shows functional blocks of the image providing system 1 of the example. Respective functions of the image providing system 1 can be constituted of a circuit block, a memory, and other LSIs in terms of hardware or are implemented by system software, an application program, or the like loaded in a memory in terms of software. Accordingly, it can be understood by those skilled in the art that the respective functions of the image providing system 1 can be implemented in various forms by hardware solely, software solely, or a combination of hardware and software, and are not limited to either one.

The in-vehicle device 20 transmits the vehicle information including a captured image in front of the vehicle to the server device 22. The in-vehicle device 20 receives the provision of the model image 12 from the server device 22 during a route guide as needed. The server device 22 has a first server device 22 that collects the captured images from a plurality of in-vehicle devices 20 and generates a model image from the captured images, and a second server device 22b that provides the model image 12 to the in-vehicle device 20. The first server device 22a and the second server device 22b may be provided in the same data center or may be provided in different data centers, respectively. That is, the first server device 22a and the second server device 22b may be one server device or may be separate server devices.

The in-vehicle device 20 includes an imaging unit 24, a position detection unit 26, a navigation unit 28, a traveling environment detection unit 30, a vehicle information holding unit 32, an in-vehicle communication unit 34, an image processing unit 36, and a display controller 38. The first server device 22a has a first communication unit 40a, a first acquisition unit 42a, a model generation unit 44, and a first holding unit 48a. The second server device 22b has a second communication unit 40b, a second acquisition unit 42b, a model decision unit 46, a second holding unit 48b, and a providing unit 50.

The imaging unit 24 acquires a captured image obtained by capturing an image in front of the vehicle, and acquires an imaging time at which the captured image is acquired. The captured image includes a traveling road as shown in FIG. 1. The position detection unit 26 acquires positional information of the vehicle and an acquisition time of the positional information using a global positioning system (GPS).

The navigation unit 28 executes a navigation function of guiding the vehicle to a destination, acquires destination information from an input of an occupant, and generates guide route information from a current vehicle position to the destination. The guide route information may be generated on the server device 22 side based on the destination information transmitted from the in-vehicle device 20.

The traveling environment detection unit 30 detects traveling environment information indicating a traveling environment outside the vehicle, and acquires a detection time of the traveling environment information. The traveling environment information includes, for example, at least one of weather information around the vehicle, brightness around the vehicle, and time period information. The weather information and brightness around the vehicle may be detected by analyzing the captured image detected by the imaging unit 24. The brightness around the vehicle may be acquired based on a detection result of a light amount sensor.

The vehicle information holding unit 32 holds vehicle type information and a vehicle ID. The in-vehicle communication unit 34 attaches the vehicle ID to the captured image, the positional information of the vehicle, the guide route information, the traveling environment information, and the vehicle type information, and transmits these kinds of information to the first communication unit 40a and the second communication unit 40b of the server device 22. A transmission timing of each of the vehicle information may be different. For example, the captured image may be collectively transmitted at a timing at which ignition is off or at a timing, such as every day or every week. On the other hand, the positional information of the vehicle, the guide route information, and the traveling environment information may be transmitted cyclically during vehicle traveling. The vehicle type information may be held in the server device 22 in advance in association with the vehicle ID and may not be transmitted to the server device 22.

The in-vehicle communication unit 34 receives the model image 12 according to the position of the vehicle and the guide route. The image processing unit 36 executes processing for superimposing the model image 12 on the captured image, which will be described below in detail. The display controller 38 executes control for making the display device 10 display the route guide image 10a generated by the image processing unit 36. The display controller 38 may make a small-scale map or a menu image beside the route guide image 10a be displayed simultaneously with the display of the route guide image 10a.

Model generation processing that is executed by the first server device 22a does not need to be executed immediately upon receiving the captured image, and thus, is executed, for example, every week. The first acquisition unit 42a acquires the captured image, the positional information of the vehicle, the traveling environment information, and the vehicle ID through the first communication unit 40a. With matching of an imaging time and the captured image and an acquisition time of the positional information of the vehicle, it is possible to acquire imaging position information indicating a position where the captured image is captured. Furthermore, with matching of the imaging time of the captured image and the detection time of the traveling environment information, it is possible to acquire the traveling environment information when the captured image is captured.

The model generation unit 44 extracts an image of a model vehicle turning at an intersection included in the captured image and generates the model image 12. The model generation unit 44 holds in advance intersection position information indicating a position of the intersection for which the model image 12 is to be generated. The intersection position information is set at an intersection with no mark, such as a POI. With this, a captured image of an intersection with no mark can be collected.

The model generation unit 44 analyzes the captured image captured at the position indicated by the intersection position information, and in a case where a model vehicle turning at the intersection is included in the captured image, cuts the model vehicle turning at the intersection from the captured image to make the model image 12. A route of the model vehicle turning at the intersection, that is, a traveling direction of turning at the intersection is derived based on the positional information of the vehicle that has transmitted the captured image and the movement of the model vehicle turning at the intersection shown in a series of captured images. The model image 12 may be generated by cutting solely the model vehicle or may be generated in a form of also including a background image around the model vehicle.

The model generation unit 44 derives positional information of the model vehicle turning at the intersection based on the captured image and the imaging position information. The model generation unit 44 analyzes the captured image to derive the distance between the model vehicle and the captured vehicle, and derives the positional information of the model vehicle based on the derived distance and the positional information of the captured vehicle. The model generation unit 44 derives vehicle type information of the model vehicle through image analysis. The vehicle type information classifies the size of the model vehicle into a plurality of stages. For example, the size of the vehicle is classified into three stages. The traveling direction of the model vehicle is derived through analysis of the positional information of the vehicle and the captured image.

In this way, the model generation unit 44 extracts the model image 12 from the captured image, and derives the traveling direction, the positional information, and the vehicle type information of the model vehicle shown in the model image 12. The model generation unit 44 executes processing for extracting the model image 12 on a series of captured images, and generates a series of images indicating the movement of the model vehicle turning at the intersection.

The first holding unit 48a holds a series of model images 12 generated by the model generation unit 44 in association with the imaging position information of the model image 12, the traveling direction of the model vehicle, the positional information of the model vehicle, the vehicle type information of the model vehicle, and the traveling environment information when the model vehicle is imaged. The first holding unit 48a holds the captured image including the model image 12 in a form capable of separating the model image 12 and a background image other than the model image 12. In this way, the model image 12 is held along with a plurality of pieces of attribute information.

Model providing processing that is executed by the second server device 22b is executed immediately upon receiving the guide route information of the vehicle. The second acquisition unit 42b acquires the positional information of the vehicle, the traveling environment information, the guide route information, the vehicle type information, and the vehicle ID through the second communication unit 40b. In the server device 22, the first acquisition unit 42a and the second acquisition unit 42b are simply referred to as an acquisition unit 42 when there is no need for distinction therebetween.

The second holding unit 48b receives the model image 12 and the attribute information from the first server device 22a, and holds the model image 12. The second holding unit 48b holds the model image 12 in association with the imaging position information of the model image 12, the traveling direction of the model vehicle, the positional information of the model vehicle, the vehicle type information of the model vehicle, and the traveling environment information when the model vehicle is imaged. The first holding unit 48a and the second holding unit 48b are simply referred to as a holding unit 48 when there is no need for distinction therebetween.

The model decision unit 46 decides the model image 12 to be provided to a vehicle scheduled to turn at a predetermined intersection based on at least one of the positional information or the guide route information of the vehicle acquired through the acquisition unit 42. The predetermined intersection is an intersection shown in the intersection position information used in generating the model image 12, and is, for example, a place with no mark. The model decision unit 46 may start the processing for deciding the model image 12 to be provided at a timing at which the guide route information of the vehicle is received. That is, the processing for deciding the model image 12 is started at a timing at which the driver sets a destination and receives a guide.

The model decision unit 46 decides the model image 12 to be provided to the vehicle scheduled to turn at the predetermined intersection based on the vehicle type information of the vehicle acquired through the acquisition unit 42 and the vehicle type information associated with the model image 12. That is, the model decision unit 46 decides to provide the model image 12 associated with the vehicle type information of the model vehicle corresponding to the vehicle type information of the vehicle. With this, it is possible to show the driver the movement of the model vehicle having the same size as the host vehicle, and to allow the driver to easily ascertain a way of turning at the intersection.

The model decision unit 46 decides the model image 12 to be provided to the vehicle scheduled to turn at the predetermined intersection based on the traveling environment information acquired through the acquisition unit 42 and the traveling environment information associated with the model image 12. That is, the model decision unit 46 decides to provide the model image 12 associated with the traveling environment information similar to the traveling environment information of the vehicle. For example, in a case where the vehicle is scheduled to turn at the intersection at rainy night, the model image 12 captured at rainy night is provided. With this, since it is possible to provide the model image 12 according to a traveling environment, it is possible to allow the driver to easily ascertain the movement of the model vehicle that has actually traveled. A case where the traveling environment information is similar means including a case where any one of the weather information, the time period, and the brightness included in the traveling environment information is different or a case where any one of the weather information, the time period, and the brightness is coincident.

The providing unit 50 provides the model image 12 decided by the model decision unit 46 to the in-vehicle device 20 through the second communication unit 40b. That is, the providing unit 50 provides the model image 12 to the vehicle scheduled to turn at the intersection included in the model image 12. The providing unit 50 provides the model image 12 to a vehicle corresponding to the vehicle type information of the model vehicle or a vehicle that is traveling in a traveling environment similar to the traveling environment information when the model image 12 is captured. In this way, it is possible to provide the model image 12 according to the size of the vehicle during traveling or a traveling environment. The model image 12 may be provided to the in-vehicle device 20 along with the positional information of the model vehicle.

The image processing unit 36 of the in-vehicle device 20 executes processing for receiving a series of model images 12 and superimposing the model image 12 on the captured image detected by the imaging unit 24. The image processing unit 36 selects the model image 12 in which the positional information of the model vehicle is at a predetermined distance from the positional information of the host vehicle, and positions feature points of the background image of the model image 12 and the captured image to derive position coordinates of the model image 12 on the captured image and to position the model image 12. The image processing unit 36 superimposes the model image 12 on the captured image in the derived position coordinates to generate the route guide image 10a. The image processing unit 36 executes processing for selecting the captured image on which the model image 12 is superimposed, that is, processing for deciding a timing of starting to display the model image 12 on the captured image in a superimposed manner, processing for positioning the model image 12 on the captured image, and processing for superimposing the model image 12 on the captured image. In this way, with the use of the positional information of the model vehicle and the background image of the model image 12, it is possible to dispose the model image 12 on the captured image with excellent accuracy.

In the processing for selecting the captured image on which the model image 12 is superimposed, when the positional information of the host vehicle matches the imaging position information associated with the model image 12, the image processing unit 36 may execute the processing for superimposing the model image 12 on the captured image. The image processing unit 36 may execute the processing for superimposing the model image 12 on the captured image based on the positional information of the model vehicle and the imaging position information.

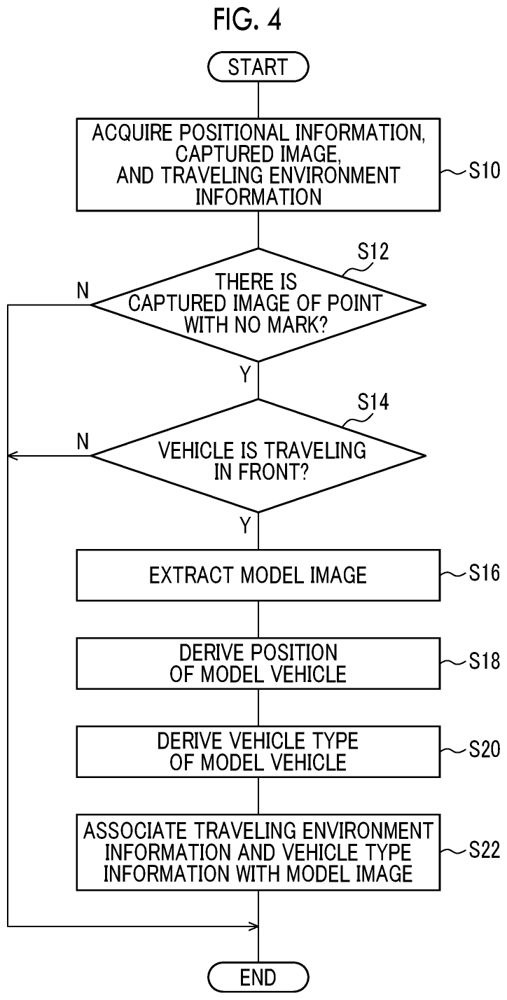

FIG. 4 is a flowchart of processing for generating the model image 12. The acquisition unit 42 of the server device 22 acquires the positional information of the vehicle, the captured image in front of the vehicle, and the traveling environment information of the vehicle (S10). The processing for generating the model image 12 is executed on captured images for a day or captured images for a week. An acquisition timing of each of the positional information, the captured image, and the traveling environment information may be different, but it is possible to match each of the positional information, the captured image, and the traveling environment information with a time stamp attached thereto.

The model generation unit 44 determines whether or not the imaging position information of the captured image matches the intersection position information for which the model image 12 is to be generated, that is, whether or not there is a captured image at an intersection with no mark (S12). In a case where there is no captured image at an intersection with no mark (N in S12), the processing ends.

In a case where there is a captured image at an intersection with no mark (Y in S12), the model generation unit 44 determines whether or not a series of captured images shows that a vehicle turning at an intersection is traveling (S14). When a vehicle turning at an intersection is not shown in the captured image (N in S14), the processing ends.

When a vehicle turning at an intersection is shown in the captured image (Y in S14), the model generation unit 44 extracts the vehicle turning at the intersection included in the captured image as a model vehicle to generate the model image 12 (S16).

The model generation unit 44 derives the distance between the captured vehicle and the model vehicle through image analysis and derives the positional information of the model vehicle based on the derived distance and the imaging position information (S18). Furthermore, the model generation unit 44 derives the vehicle type information of the model vehicle through image analysis (S20).

The holding unit 48 holds the traveling environment information, the vehicle type information, the positional information of the model vehicle, and the imaging position information in association with the model image 12 (S22). In this way, the model image 12 is held along with a plurality of pieces of attribute information.

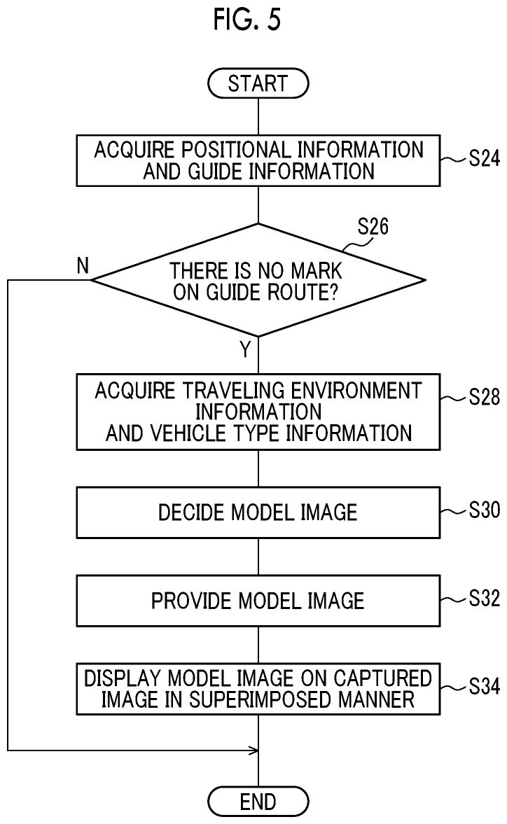

FIG. 5 is a flowchart of processing for providing the model image 12. The in-vehicle device 20 in operation transmits the positional information and the guide route information of the vehicle to the server device 22 cyclically, and the acquisition unit 42 of the server device 22 acquires the positional information and the guide route information of the vehicle (S26).

The model decision unit 46 determines whether or not the vehicle is scheduled to turn at a predetermined intersection based on the guide route information of the vehicle (S26). When the vehicle is not scheduled to turn at the predetermined intersection (N in S26), the processing ends.

When the vehicle is scheduled to turn at the predetermined intersection (Y in S26), the acquisition unit 42 acquires the traveling environment information and the vehicle type information of the vehicle (S28), and the model decision unit 46 decides to provide the model image 12 corresponding to the traveling environment information and the vehicle type information of the vehicle (S30). The providing unit 50 provides the decided model image 12 to the in-vehicle device 20 through the second communication unit 40b (S32).

The image processing unit 36 of the in-vehicle device 20 superimposes the model image 12 on the captured image to generate the route guide image 10a, and the display controller 38 makes the display device 10 display the route guide image 10a (S34).

The disclosure has been described based on the embodiment and a plurality of examples. The disclosure is not limited to the above-described embodiment and examples, and may be subjected to modifications, such as various design changes, based on common knowledge of those skilled in the art.

In the example, although an aspect in which the display device 10 is an in-vehicle display has been described, the disclosure is not limited to the aspect, and the display device 10 may be a head-up display. The head-up display displays a display image as a virtual image on an actual scene in a superimposed manner by projecting a model image in front of the driver.

In the example, although an aspect in which the in-vehicle device 20 executes the processing for superimposing the model image 12 on the captured image has been described, the disclosure is not limited to the aspect, and the server device 22 may execute the processing for superimposing the model image 12 on the captured image.

What is claimed is:

1. A server device comprising:
an acquisition unit configured to acquire, from an in-vehicle device, a captured image obtained by capturing an image in front of a vehicle and imaging position information indicating a position where the captured image is captured;
a holding unit configured to hold a model image, which is generated from a series of captured images including a vehicle turning at an intersection and includes a vehicle turning at the intersection as a model vehicle, in association with the imaging position information; and
a providing unit configured to provide the model image to a vehicle scheduled to turn at the intersection corresponding to the model image.

2. The server device according to claim 1, wherein:
the holding unit holds vehicle type information of the model vehicle in association with the model image; and
the providing unit provides the model image including the model vehicle corresponding to the vehicle type information of a vehicle scheduled to turn at an intersection included in the model image.

3. The server device according to claim 1, wherein:
the acquisition unit acquires traveling environment information indicating a traveling environment of a vehicle when the model image is captured;
the holding unit holds the traveling environment information when the model image is captured in association with the model image; and
the providing unit provides the model image associated with traveling environment information similar to a traveling environment of a vehicle scheduled to turn at an intersection included in the model image to the scheduled vehicle.

4. A method of providing an image, the method comprising:
a step of acquiring, from an in-vehicle device, a captured image obtained by capturing an image in front of a vehicle and imaging position information indicating a position where the captured image is captured;
a step of holding a model image, which is generated from a series of captured images including a vehicle turning at an intersection and includes a vehicle turning at the intersection as a model vehicle, in association with the imaging position information; and
a step of providing the model image to a vehicle scheduled to turn at the intersection corresponding to the model image.
